(19) United States
(12) Patent Application Publication
(10) Pub. No.: US 2025/0338305 A1
(43) Pub. Date: Oct. 30, 2025

(54) OFDMA OPERATION UNDER COEXISTENCE CONSTRAINT

(71) Applicant: Samsung Electronics Co., Ltd., Suwon-si (KR)

(72) Inventors: Peshal Nayak, Plano, TX (US); Vishnu Vardhan Ratnam, Frisco, TX (US); Bilal Sadiq, Plano, TX (US); Rubayet Shafin, Allen, TX (US); Boon Loong Ng, Plano, TX (US); Yue Qi, Plano, TX (US)

(21) Appl. No.: 19/096,570

(22) Filed: Mar. 31, 2025

Related U.S. Application Data
(60) Provisional application No. 63/639,364, filed on Apr. 26, 2024.
(60) Provisional application No. 63/766,093, filed on Mar. 3, 2025.

(51) Int. Cl. H04W 72/541

(52) U.S. Cl. CPC H04W 72/541

(57) ABSTRACT

An embodiment includes a STA with low latency traffic may transmit a defer signal to preempt one or more others STAs from contending for channel access, whereby the STA may quickly obtain channel access to transmit low latency frames, whereby the defer signal may place the one or more other STAs in an extended interframe space (EIFS) state or in an error state.

### CROSS-REFERENCE TO RELATED APPLICATIONS

This application claims the benefit of priority from U.S. Provisional Application No. 63/639,364, entitled “OFDMA OPERATION UNDER COEXISTENCE CONSTRAINT filed Apr. 26, 2024; and U.S. Provisional Application No. 63/766,093, entitled “OFDMA OPERATION UNDER COEXISTENCE CONSTRAINT filed Mar. 3, 2025; which are all incorporated herein by reference in their entireties.

### TECHNICAL FIELD

This disclosure relates generally to a wireless communication system, and more particularly to, for example, but not limited to, Orthogonal Frequency-Division Multiple Access (OFDMA) operation under co-existence constraint in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides station (STA) in a wireless network, the STA comprising: a memory; and a processor coupled to the memory. The processor is configured to transmit, to an access point (AP), a first frame using a first communication protocol, the first frame indicating unavailability associated with a coexistence constraint imposed by a second communication protocol, the first frame including resource information indicating an unavailable resource. The processor is configured to receive, from the AP, a second frame using the first communication protocol, the second frame allocating a resource that is determined to avoid interference by the coexistence constraint. The processor is configured to perform communication with the AP based on the allocated resource.

In some embodiments, the first frame indicates a first resource unit that is unavailable by the coexistence constraint, and the second frame allocates a second resource unit that is determined to avoid the interference.

In some embodiments, the first frame indicates a duration of unavailability of the first resource unit.

In some embodiments, the first frame includes: a first field indicating one or more resource units that are unavailable; a second field indicating a start time of unavailability for the one or more resource units; and a third field indicating a duration of unavailability for the one or more resource units.

In some embodiments, the processor is further configured to receive, from the AP, a third frame that solicits the first frame.

In some embodiments, the third frame includes information on one or more resource units that are allowed to be allocated to the STA.

In some embodiments, the processor is further configured to receive, from the AP, a frame that indicates a capability to support resource allocation based on the coexistence constraint.

In some embodiments, the processor is further configured to transmit, to the AP, a frame that indicates a capability to support resource allocation based on the coexistence constraint.

One aspect of the present disclosure provides an access point (AP) in a wireless network, the AP comprising: a memory; and a processor coupled to the memory. The processor is configured to receive, from a station (STA), a first frame, the first frame indicating unavailability associated with a coexistence constraint imposed by a communication protocol that is different than a communication protocol used by the AP, the first frame including resource information indicating an unavailable resource. The processor is configured to transmit, to the STA, a second frame, the second frame allocating a resource that is determined to avoid interference by the coexistence constraint. The processor is configured to perform communication with the STA based on the allocated resource.

In some embodiments, the first frame indicates a first resource unit that is unavailable by the coexistence constraint; and the second frame allocates a second resource unit that is determined to avoid the interference.

In some embodiments, the first frame indicates a duration of unavailability of the first resource unit.

In some embodiments, the first frame includes: a first field indicating one or more resource units that are unavailable; a second field indicating a start time of unavailability for the one or more resource units; and a third field indicating a duration of unavailability for the one or more resource units.

In some embodiments, the processor is further configured to transmit, to the STA, a third frame that solicits the first frame.

In some embodiments, the third frame is transmitted to a plurality of STAs and includes identification information for the plurality of STAs that the third frame is intended for.

In some embodiments, the third frame includes information on one or more resource units that are allowed to be allocated to the STA.

In some embodiments, the processor is further configured to transmit, to the STA, a frame that indicates a capability to support resource allocation based on the coexistence constraint.

In some embodiments, the processor is further configured to receive, from the STA, a frame that indicates a capability to support resource allocation based on the coexistence constraint.

One aspect of the present disclosure provides a computer-implemented method for wireless communication by a station (STA) in a wireless network. The method comprises transmitting, to an access point (AP), a first frame using a first communication protocol, the first frame indicating unavailability associated with a coexistence constraint imposed by a second communication protocol, the first frame including resource information indicating an unavailable resource. The method comprises receiving, from the AP, a second frame using the first communication protocol, the second frame allocating a resource that is determined to avoid interference by the coexistence constraint. The method comprises performing communication with the AP based on the allocated resource.

In some embodiments, the first frame indicates a first resource unit that is unavailable by the coexistence constraint; and the second frame allocates a second resource unit that is determined to avoid the interference.

In some embodiments, he first frame indicates a duration of unavailability of the first resource unit.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a ranging round in accordance with an embodiment.

FIG. 5 illustrates an example ZigBee timeline in accordance with an embodiment.

FIG. 6 illustrates an example of uplink (UL) OFDMA procedure in accordance with an embodiment.

FIG. 7 illustrates an example of downlink (DL) OFDMA procedure in accordance with an embodiment.

FIG. 8 illustrates a UL OFDMA under a co-existence event in accordance with an embodiment.

FIG. 9 illustrates an example of a downlink DL OFDMA under co-existence event in accordance with an embodiment.

FIG. 10 illustrates a flow chart of an example process by a STA of providing a co-existence mode indication in accordance with an embodiment.

FIG. 11 illustrates negotiation for RU allocation in accordance with an embodiment.

FIG. 12 illustrates a feedback element in accordance with an embodiment.

FIG. 13 illustrates an example operation with an initial control frame request and initial control frame response negotiation in accordance with an embodiment.

FIG. 14 illustrates an STA refraining from participating in UL-OFDMA due to know co-existence event occurrence in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

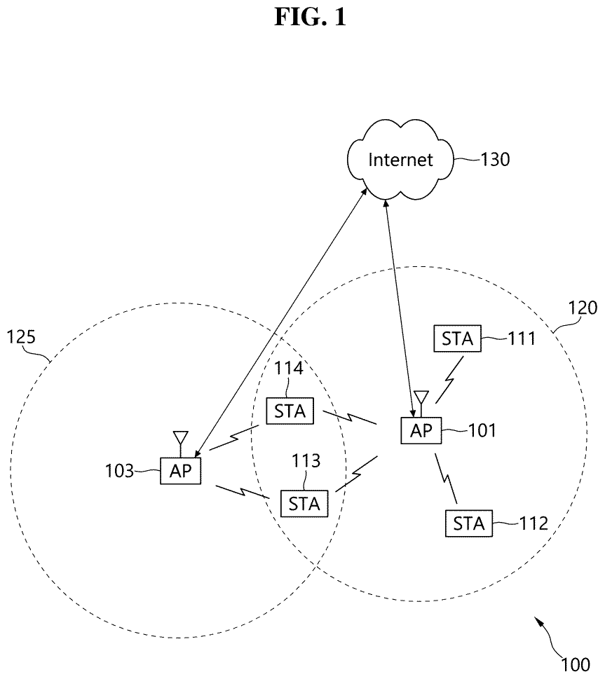

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

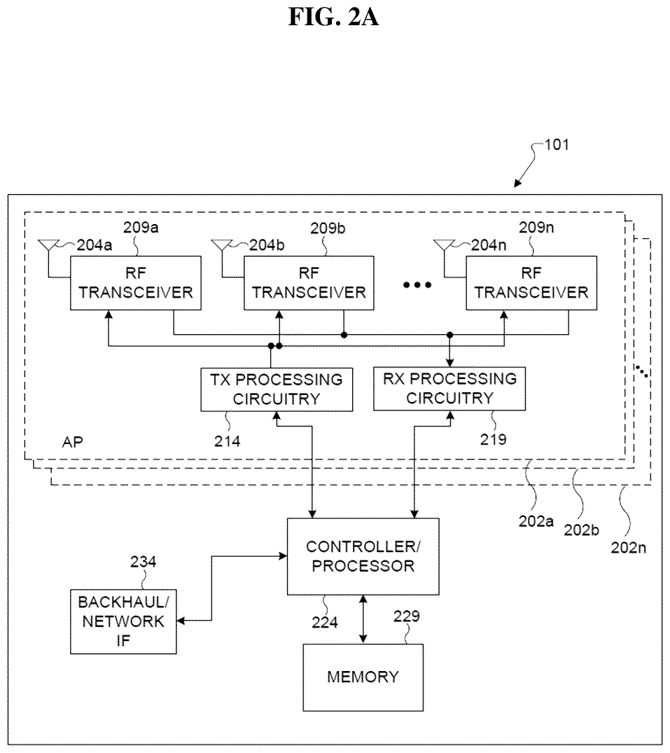

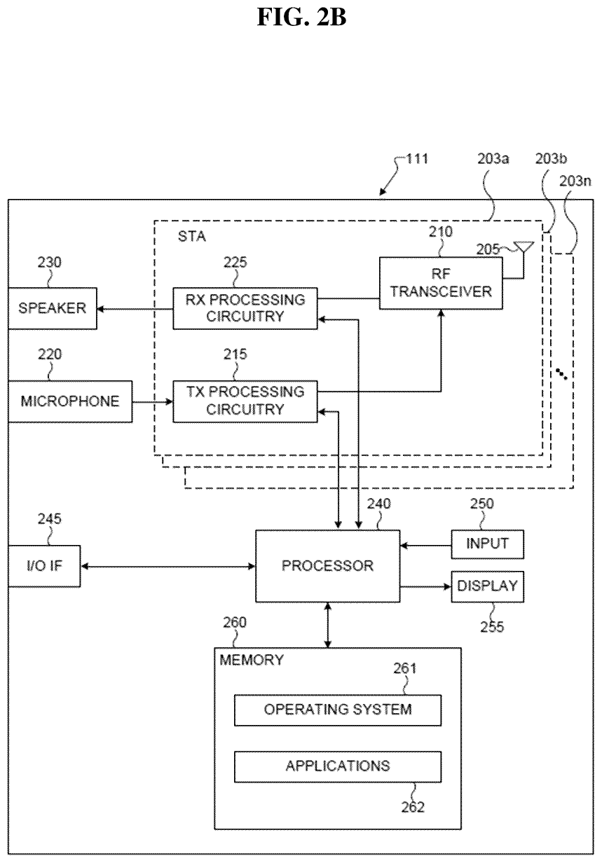

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

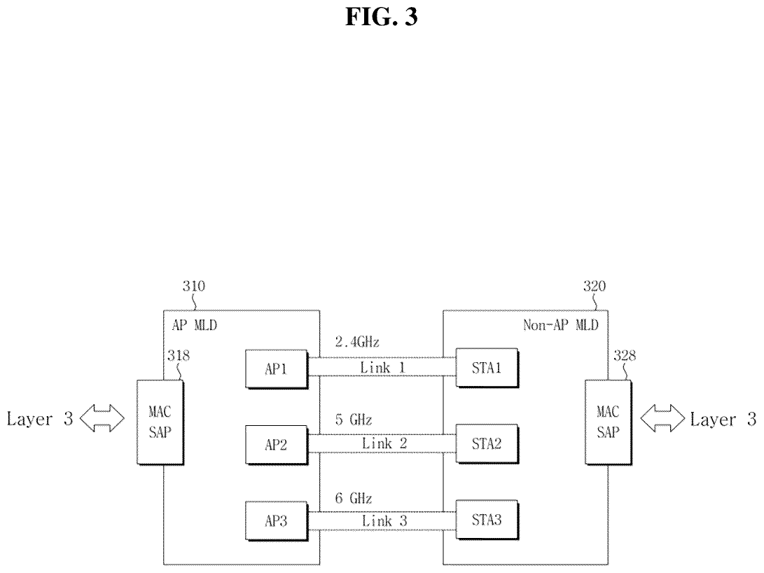

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

Wireless devices can have a number of Wi-Fi and non-Wi-Fi radios that can co-exist on the same device. Some non-Wi-Fi technology radios that may co-exist with Wi-Fi include Bluetooth, Ultra-Wide Band (UWB), Zigbee, among others.

Bluetooth is a wireless technology that started off as a short-distance cable replacement mechanism. Bluetooth Classic, which may be used for streaming applications (e.g., headset), operates on 79 radio frequency (RF) channels each spaced 1 MHz apart. Bluetooth Low Energy (BLE) on the other hand, which is used for Internet of Things (IoT) applications, operates on 40 RF channels each spaced 2 MHz apart. In the case of Bluetooth, some channels may be reserved specifically for the purpose of advertisement and others may be used for secondary advertisement for data transmission. In the case of Bluetooth classic, 32 channels are reserved for advertisement whereas in the case of BLE, 3 channels are reserved for advertisement.

In Bluetooth, transmission may happen as a part of a connection event. During a connection event, two devices that are engaged in data transmission alternate sending data until the data to be sent on both sides is exhausted. One of the devices acts as the master and the other device acts as the slave. The master sends a packet to the slave and if the slave receives the packet it sends back a packet to the master. The duration between two connection events is called a connection interval. Connection interval values can range from, for example, 7.5 microseconds (ms) to 4 seconds. The exact value can be negotiated between the master and the slave to optimize their power saving while balancing latency incurred. Bluetooth transmissions may follow a frequency hopping spread spectrum method where a hopping sequence is used to rapidly hop between data channels.

As Bluetooth and Wi-Fi follow different channel access protocols, coexistence of Bluetooth can lead to interference to Wi-Fi transmission. Some Bluetooth transmissions can be scheduled making the interference more predictable. However, in other cases, Bluetooth interference can be hard to predict in advance. Thus, Wi-Fi would benefit from having mechanisms to react to Bluetooth interference when it occurs in such cases.

Bluetooth is used for a large number of applications such as streaming applications, sensor applications, navigation based on beaconing, among others. Wi-Fi routers from certain vendors may also come equipped with Bluetooth radios for the purpose of navigation or location awareness applications. Furthermore, an end user's phone may also be configured as a Mobile AP which can also have Bluetooth operating on it.

Bluetooth has primarily operated on the 2.4 GHz band. However, in the next generation Bluetooth technology, the operation is expected to be extended to the 5 GHz and 6 GHz bands as well. Thus, the interference problem can be worse for Wi-Fi operation which also uses these bands for communication.

Ultra-Wide Band (UWB) has recently become popular for use cases involving indoor positioning and navigation using the 6 GHz band. The IEEE 802.15.4 amendment defines a block based mode for ranging in which there are ranging blocks which are divided into ranging rounds which are further divided into ranging slots. The number of ranging rounds in a ranging block, the number of ranging slots in a ranging round and the duration of ranging slot are transmitted by the controller in ranging control message (RCM) to the participant devices. The information can be for a current ranging round and potential subsequent ranging rounds as well. A ranging slot in which the device is expected to be active is referred to as active slots. There can also be inactive and silent periods.

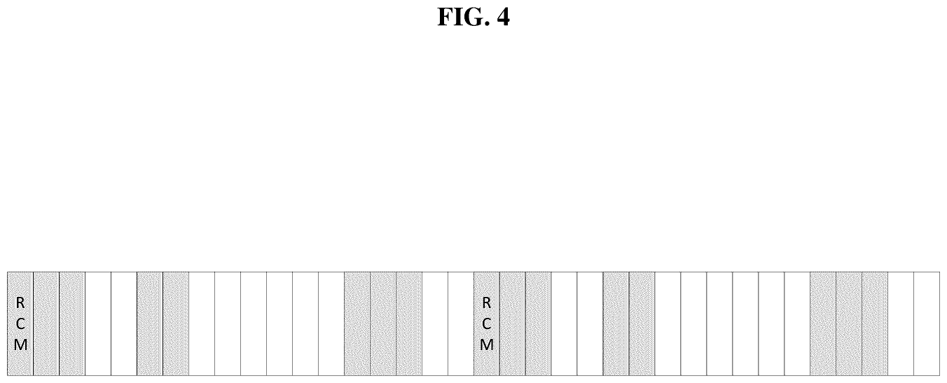

FIG. 4 illustrates a ranging round in accordance with an embodiment. The active slots are shown as shaded and inactive or silent slots are shown in white. Furthermore, FIG. 4 illustrates several ranging control messages (RCM) that include the number of ranging rounds in a ranging block, the number of ranging slots in a ranging round and the duration of ranging slot.

The ZigBee protocol is another technology developed for smart home applications. The protocol operates based on the concept of beacon intervals.

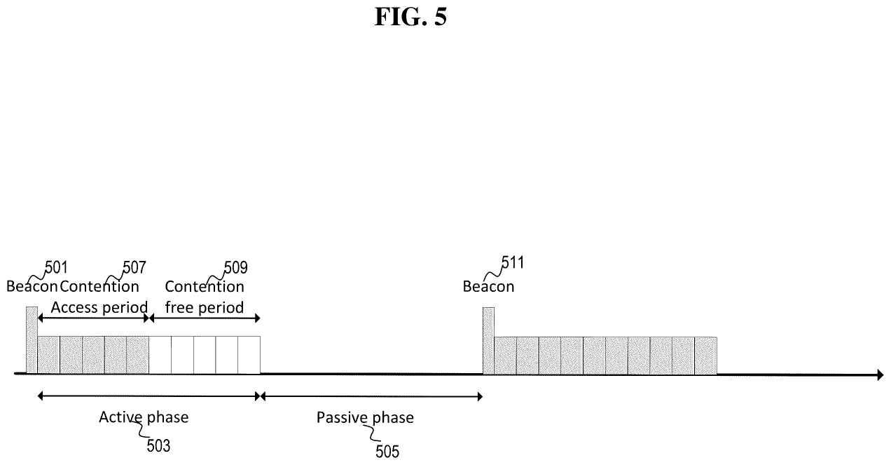

FIG. 5 illustrates an example ZigBee timeline in accordance with an embodiment. In particular, FIG. 5 illustrates a beacon interval 501, an active phase 503, and a passive phase 505 for Zigbee. The beacon 501 is followed by an active phase 503 that includes a contention access period 507 and a contention free period 509, followed by a passive phase 505. The coordinator in a ZigBee operation sends out periodic beacons, illustrated as beacon 501 and beacon 511. Each beacon is followed by the start of an active phase 503. The beacon 501 may announce the duration of the active phase 503 and the time until the next beacon transmission 511. Each beacon interval thus is divided into two phases. First, an active phase 503 which starts right after the beacon 501. Second, a passive phase 505 for power save. As noted, the active phase 503 can be divided into contention based period 507 and contention free period 509. The duration of each of the phases (e.g., active phase and passive phase) and the beacon interval can be characterized by aBaseSlotDuration value, macBeaconOrder (BO) and mac SuperframeOrder (SO). BO and SO are integer values ranging from 0 to 14. The beacon interval can be computed as aBaseSuperframeDuration*2^{BO} and the active phase can be computed as aBaseSuperframeDuration*2^{SO} where aBaseSuperframeDuration=16*aBaseSlotDuration.

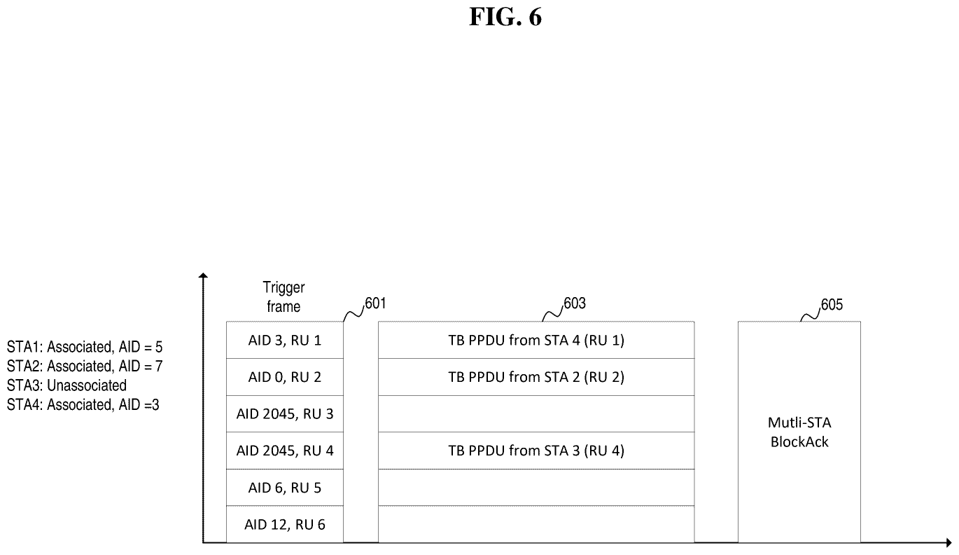

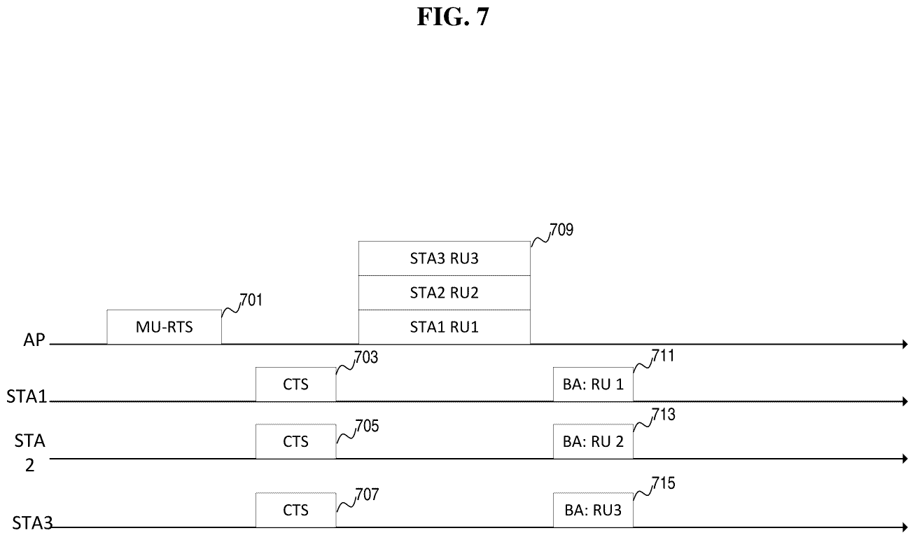

Orthogonal frequency division multiple access (OFDMA) can enable an AP to allocate multiple resource units (RUs) for transmission and reception. During OFDMA operation, the AP can assign different RUs to different STAs for uplink transmission. This is done by transmission of a trigger frame at the start of the transmission. The trigger frame can indicate the RUs on which different STAs can transmit to the AP. The AP can also allocate one or more RUs for random access based transmission. A few examples of OFDMA for uplink and downlink are shown in FIG. 6 and FIG. 7 in accordance with an embodiment.

FIG. 6 illustrates an example of uplink (UL) OFDMA procedure in accordance with an embodiment. In particular, FIG. 6 illustrates an AP that transmits a trigger frame 601, which assigns different RUs to different STAs for uplink transmission. In particular the trigger frame 601 indicates that association identifier (AID) 3 is assigned RU 1, AID 0 is assigned RU 2, AID 2045 is assigned RU 3, AID 2045 is assigned RU 4, AID 6 is assigned RU 5, and AID 12 is assigned RU 6. As described herein, an AID equal to 0 indicates that all associated STAs may contend and capture the channel and an AID equal to 2045 may indicate that any unassociated STAs may contend and capture the channel. Accordingly, in response to the trigger frame 601, the AP receives an uplink transmission that includes a trigger based (TB) physical layer protocol data unit (PPPDU) from STA 4, which has AID 3, on RU1, TB PPDU from STA 2 on RU 2, and TB PPDU from STA 3 on RU 4. The AP transmits a multi-STA block acknowledgement 605.

FIG. 7 illustrates an example of downlink (DL) OFDMA procedure in accordance with an embodiment. In particular, FIG. 7 illustrates communication among AP, STA1, STA2, and STA3. The AP transmits to the STAs a Multi-User Request To Send (MU-RTS) frame 701. In some embodiments, a MU-RTS frame may be a control frame that is used by the AP to coordinate simultaneous transmissions from multiple STAs (e.g., STA1, STA2, and STA3) and may signal RU assignments and timing information. In response to the MU-RTS frame 701, STA1 transmits to the AP a Clear to Send (CTS) frame 703, STA2 transmits to the AP CTS frame 705, and STA3 transmits to the AP CTS 707 frame. In some embodiments, a CTS frame is a control frame sent by a STA in response to the RTS frame indicating that the channel is clear for the source station (e.g., AP) to transmit data. Accordingly, the AP transmits data 709 to each STA according to the allocated RU, which is indicated as STA3 on RU3, STA2 on RU2 and STA1 on RU1. Accordingly, STA1 transmits a block acknowledgment (BA) 711 using RU1, STA2 transmits a BA 713 on RU2, and STA3 transmits a BA 715 on RU3.

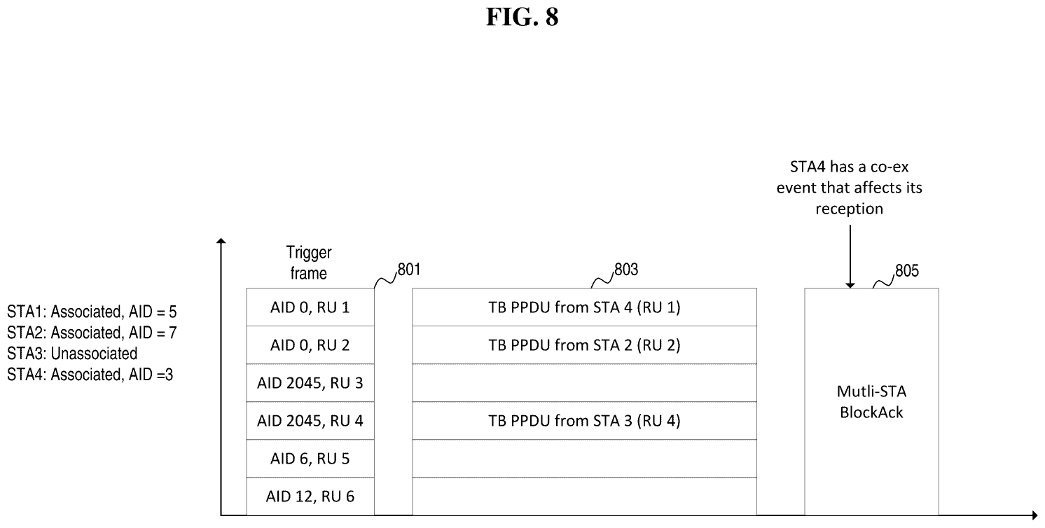

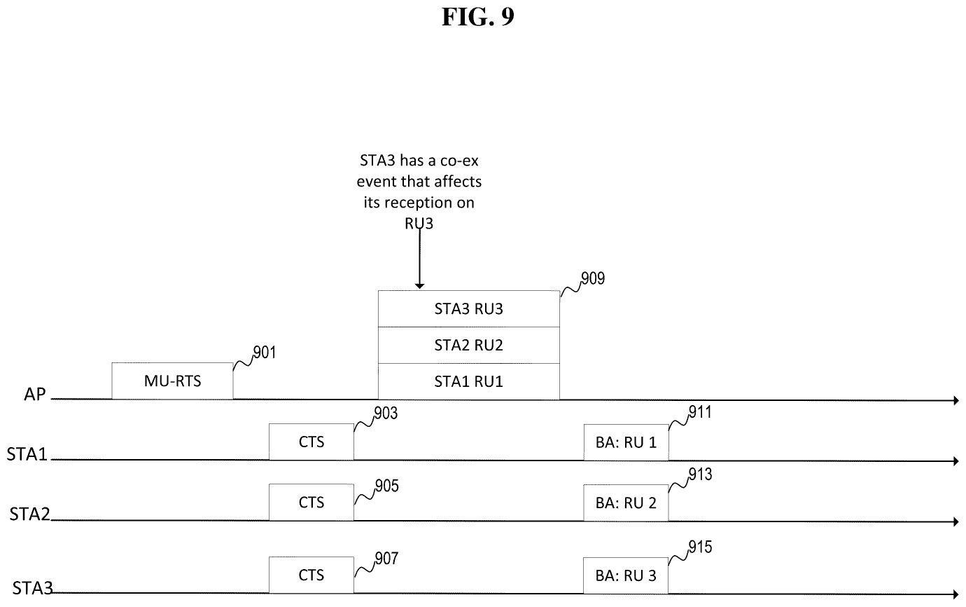

When performing OFDMA, if one or more of the STAs has a co-existence (Co-Ex) event during a transmission, this can affect the overall medium usage. Two examples can be as shown in FIG. 8 and FIG. 9 in accordance with an embodiment.

FIG. 8 illustrates a UL OFDMA under a co-existence event in accordance with an embodiment. In particular, FIG. 8 illustrates the same example as FIG. 6, however, STA4 has a co-existence event that affects its reception. In particular, the AP transmits TB PPDU 803 to STA4 on RU1, however, STA4 has a co-existence event that affects its reception.

FIG. 9 illustrates an example of a downlink (DL) OFDMA under co-existence event in accordance with an embodiment. In particular, FIG. 9 illustrates the same example as FIG. 7, however, STA3 has a co-existence event that affects its reception on RU3.

Accordingly, embodiments in accordance with this disclosure provide procedures that enable efficient usage of frequency resources when performing OFDMA under co-ex constraints.

In some embodiments, a STA may transmit a co-existence mode indication message to the AP. Based on the co-existence mode indication, the AP can know that the device has a co-existence constraint.

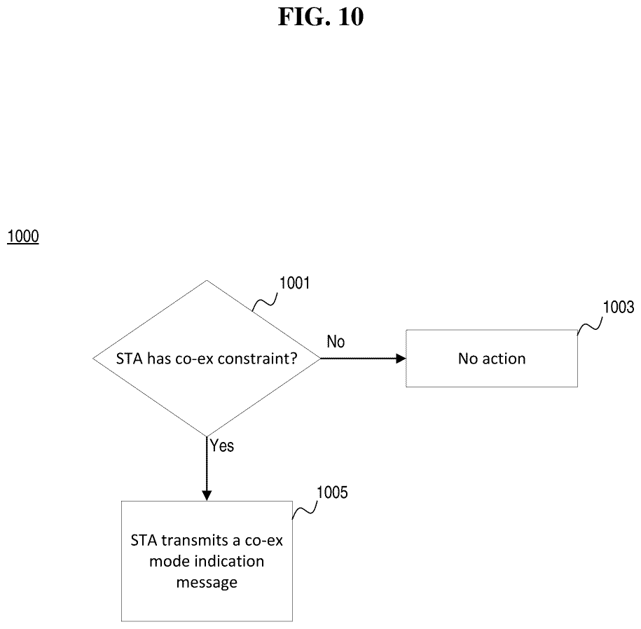

FIG. 10 illustrates a flow chart of an example process by a STA of providing a co-existence mode indication in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a STA, such as the STA illustrated in FIG. 3.

The process 1000, in operation 1001, the STA determines whether the STA has a co-existence constraint. In some embodiments, the STA may determine whether it is simultaneously using more than one communication protocol (e.g., Wi-Fi, Bluetooth, Zigbee, UWB, OFDMA, among others). If the STA determines that it does not have a co-existence constraint, the process proceeds to operation 1003 and the STA performs no action. If the STA determines that it does have a co-existence constraint, the process proceeds to operation 1005.

In operation 1005, the STA transmits a co-existence mode indication message to the AP. In some embodiments, the co-existence mode indication message can include at least one or more of the information items as indicated in Table 1.

Table 1 provides a co-existence mode indication message content in accordance with an embodiment.

TABLE 1

| Information | |
|---|---|
| item | Description |
| Co-Ex mode | An indication that the device has a co-existence constraint. e.g., a bit, |
| indicator | flag, among others. |
| Start time | An indication of the start time(s) of the co-ex event. e.g., start time of |
| | co-ex with an indication of its periodicity. |
| Duration | An indication of the duration for which the co-ex event can last. e.g., |
| | value in microseconds |
| Interval | An indication of the interval of the co-ex event. e.g., the time period |
| | between two start times. |
| Aperiodicity | An indication that the co-ex event is not periodic. e.g., can be predicted |
| indication | closer to the co-ex event but not known in advance. |
| RU indication | One or more information items that can indicate the RUs that are |
| | affected by the unavailability. |

In some embodiments, the co-existence indication message can create an awareness on the AP side about the co-existence constraint of the STA. With this knowledge the AP can trigger one or more procedures to handle the co-existence constraint of the STA.

In some embodiments, before performing OFDMA, the AP can check the RUs that can get affected for different STAs in the group due to co-existence events. The AP can transmit an initial control frame that can indicate that the AP intends to check for the STA's co-existence constraint on different RUs that can be allocated for transmission to the STA. The AP can then allocate RUs to avoid co-ex interference.

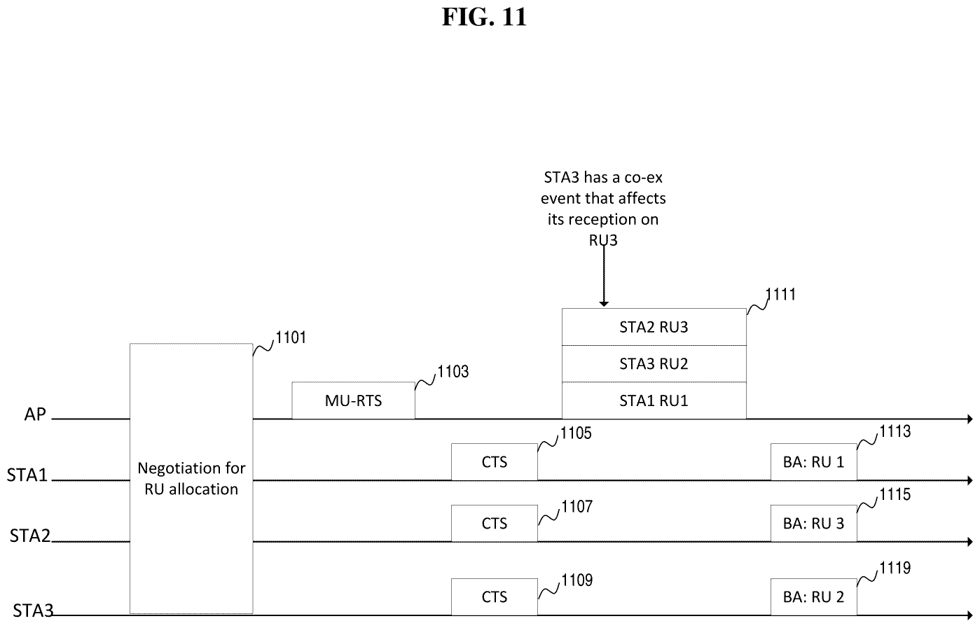

FIG. 11 illustrates negotiation for RU allocation in accordance with an embodiment. In particular, FIG. 11 illustrates communication among AP, STA1, STA2, and STA3. Initially, the AP and STA1, STA2, and STA3 may perform a negotiation 1101 for RU allocation. In particular, before performing OFDMA, the AP can check the RUs that can get affected for STA1, STA2, and STA3 in the group due to co-existence events. The AP can transmit an initial control frame that can indicate that the AP intends to check for the STA's co-existence constraint on different RUs that can be allocated for transmission to the STA. Each STA, including STA1, STA2 and STA3 can transmit a response message to the AP that includes one or more of an indication regarding whether the STA has a co-existence constraint, an indication of the start time of the co-existence event, or an indication of the duration of the co-existence event. As illustrated, only STA3 has a co-existence event that affects its reception on RU3. Based on this information, the AP can then allocate RUs to avoid co-ex interference for each of STA1, STA2, and STA3. In particular, the AP assigns STA2 to RU3, STA3 to RU2, and STA1 to RU1. After the negotiation 1101, the AP transmits a MU-RTS frame 1103 to STA1, STA2 and STA3. In response to the MU-RTS frame 1103, STA1 transmits to the AP a CTS 1105, STA2 transmits to the AP a CTS 1107, and STA3 transmits to the AP a CTS 1109, indicating that the channel is clear to send data for the AP. As such, the AP transits data frame 1111 to the STAs, where the data is transmitted to STA2 on RU3, STA3 on RU2 (thereby avoiding the co-existence event on RU3), and STA1 on RU1. Accordingly, STA1 transmits a block acknowledgment (BA) 1113 using RU1, STA2 transmits a BA 1115 on RU3, and STA3 transmits a BA 1119 on RU2.

In some embodiments, the negotiation procedure can include a request and response message exchange. In some embodiments, the request frame can be transmitted by the AP and can include one or more of the information items as indicated in Table 2.

Table 2 provides information items that can be present in a request message in accordance with an embodiment.

TABLE 2

| Information | |
|---|---|
| item | Description |
| Request | One or more information items that can indicate that the message is |
| Indication | requesting information on RUs facing unavailability constraints. e.g., a |
| | bit, flag, or code that can indicate that the AP is requesting information |
| | on RU availability. |
| STA identifier set | One or more information items that can indicate the STAs that the |
| | message is intended for. Those STAs can respond back with an initial |
| | control response (ICR). e.g., STA's AID, MAC addresses, among |
| | others. |
| Allocation RU set | One or more information items that can indicate the RUs that the AP |
| | can allocate for the following transmissions. The STA(s) can indicate |
| | the RUs on which they are unavailable. |

Upon receiving the request message, a STA can transmit a response message that may include at least one or more of the information items as indicated in Table 3.

Table 3 provides information items that can be present in a response message in accordance with an embodiment.

TABLE 3

| Information | |
|---|---|
| item | Description |
| Unavailability | One or more information items that can indicate the RUs for which the |
| information for | STA can face an unavailability constraint or the RUs for which the STA |
| different RUs | can be available. |
| Start Time | One or more information items that can indicate the start time of |
| | unavailability for each RU. |
| Duration | One or more information items that can indicate the duration of |
| | unavailability for each RU. |

In some embodiments, upon receiving the response message information from the STA, the AP may decide the RU allocation for the STAs. In some embodiments, the AP may then transmit data to the STAs as per their availability.

In some embodiments, a response message may include a feedback subfield that can indicate RU availability.

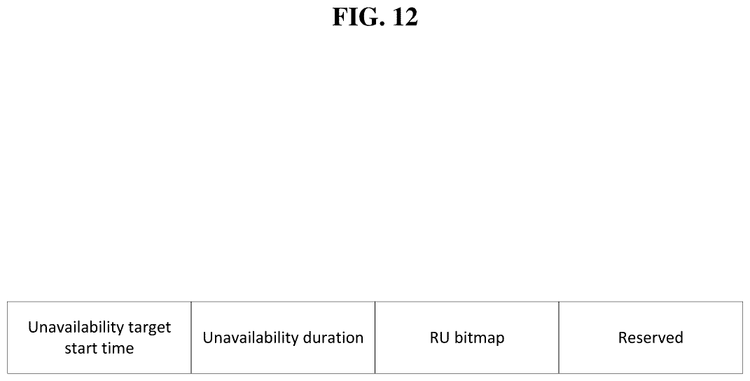

FIG. 12 illustrates a feedback element in accordance with an embodiment. The feedback element includes an unavailability target start time field, a unavailability duration field, a RU bitmap field, and a reserved field. In some embodiments, the feedback element can be included in a multi-STA BA that acts as an initial control response (ICR). The unavailability target start time field can indicate the start time of unavailability for the RUs indicated in the RU bitmap. The unavailability duration field can indicate the duration of unavailability for the RUs indicated in the RU bitmap field. The RU bitmap field can indicate the RUs on which the unavailability constraint may be encountered. Each bit of the RU bitmap can represent a 20 MHz channel. The lowest bit may correspond to the lowest frequency channel. In some embodiments, each bit can represent a specific channel.

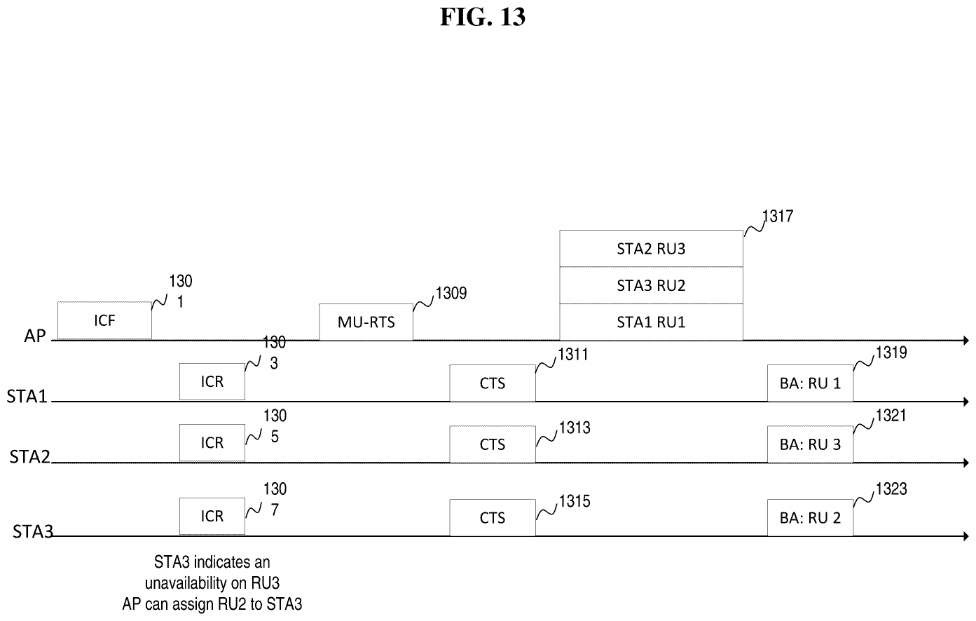

FIG. 13 illustrates an example operation with an initial control frame request and initial control frame response negotiation in accordance with an embodiment. In particular, FIG. 13 illustrates communication among AP, STA1, STA2, and STA3. Initially, the AP and STA1, STA2, and STA3 may perform a negotiation 1101 for RU allocation. In particular, before performing OFDMA, the AP can check the RUs that can get affected for STA1, STA2, and STA3 in the group due to co-existence events. The AP can transmit an initial control frame (ICF) 1301 that can indicate that the AP intends to check for the STA's co-existence constraint on different RUs that can be allocated for transmission to the STA. the ICF 1301 can carry an indication that it is for multiple STAs and provide an indication of which STAs it is intended for. The indicated STA can provide an initial control response (ICR) which can carry an indication of the RUs on which they may be unavailable. As illustrated, each STA, including STA1, STA2 and STA3 transmits an ICR 1303, 1305, and 1307 respectively, to the AP that includes an indication regarding whether the STA has a co-existence constraint, an indication of the start time of the co-existence event, an indication of the duration of the co-existence event, an indication of the interval of the co-existence event, and/or an indication that the co-existence event is not periodic. As illustrated, only STA3 has a co-existence event that affects its reception on RU3. Based on this information, the AP can assign RUs as per the STA's availability and perform DL OFDMA transmission. In some embodiments, the AP may drop a STA from a group if allocating an RU is not possible. A same procedure may be used for UL OFDMA transmission. As illustrated, the AP assigns STA2 to RU3, STA3 to RU2, and STA1 to RU1. After the negotiation, the AP transmits a MU-RTS frame 1309 to STA1, STA2 and STA3. In response to the MU-RTS frame 1309, STA1 transmits to the AP a CTS 1311, STA2 transmits to the AP a CTS 1313, and STA3 transmits to the AP a CTS 1315, indicating that the channel is clear to send data for the AP. As such, the AP transits data frame 1317 to the STAs, where the data is transmitted to STA2 on RU3, STA3 on RU2 (thereby avoiding the co-existence event on RU3), and STA1 on RU1. Accordingly, STA1 transmits a block acknowledgment (BA) 1319 using RU1, STA2 transmits a BA 1321 on RU3, and STA3 transmits a BA 1323 on RU2.

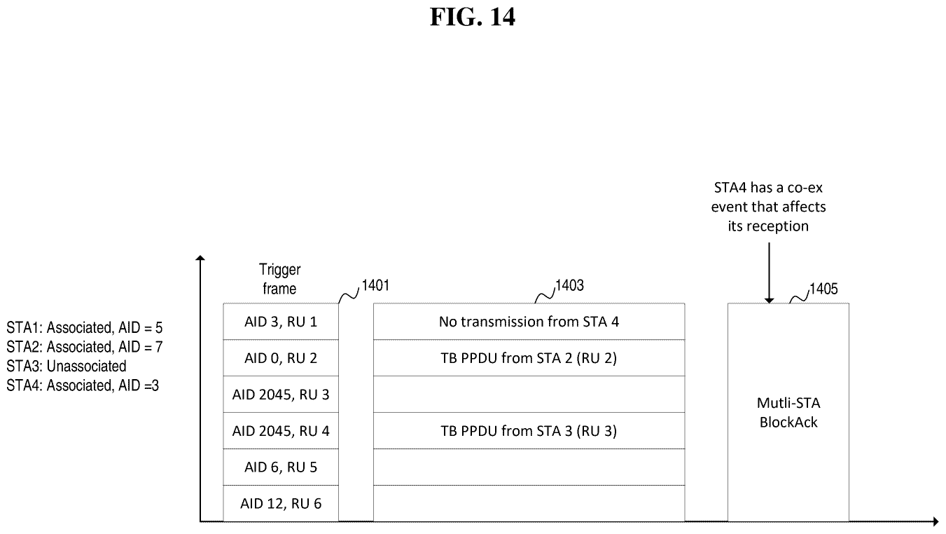

In some embodiments, the AP can also remove a STA from a group if allocating an RU is not possible. In some embodiments, the STA can also refrain from participating in the UL-OFDMA in anticipation of the impact to the STA's reception due to a co-existence event as shown in the example in FIG. 14.

FIG. 14 illustrates an STA refraining from participating in UL-OFDMA due to know co-existence event occurrence in accordance with an embodiment. In particular, FIG. 14 illustrates the same example as FIG. 6, however, as indicated, STA4 has a co-existence event that affects its reception, and thus STA4 does not participate in the UL-OFDMA, as indicated STA4 does not transmit a TB PPDU to the AP within the uplink data 1403. In particular, FIG. 14 illustrates an AP that transmits a trigger frame 1401, which assigns different RUs to different STAs for uplink transmission. In particular the trigger frame 1401 indicates that association identifier (AID) 3, corresponding to STA4, is assigned RU 1, AID 0 is assigned RU 2, AID 2045 is assigned RU 3, AID 2045 is assigned RU 4, AID 6 is assigned RU 5, and AID 12 is assigned RU 6. Accordingly, in response to the trigger frame 1401, the AP receives an uplink transmission that includes a trigger based (TB) physical layer protocol data unit (PPPDU) from STA 2 on RU 2, and TB PPDU from STA 3 on RU 3. However, there is no TB PPDU from STA4 on RU1 as STA4 has a co-existence event. The AP transmits a multi-STA block acknowledgement frame 1405 to the STAs.

In some embodiments, an AP that supports RU allocation can advertise such a capability in one or more frames that the AP can transmit. In some embodiments, there can be a capability bit that can be carried in management frames such as beacons, probe responses, (re) association responses, among others. The bit can be set to a value of 1 to indicate support and to 0 to indicate a lack of such a support. In some embodiments, a STA that supports R allocation can advertise the information in one or more frames that the STA may transmit. In some embodiments, there can be a capability bit that can be carried in management frames such as probe requests, (Re) association requests, among others. The bit can be set to 1 to indicate support and to 0 to indicate a lack of such a support.

Embodiments in accordance with this disclosure provide procedures that enable efficient usage of frequency resources when performing OFDMA under co-existence constraints. In some embodiments, a STA may transmit a co-existence mode indication message to the AP. Based on the co-existence mode indication, the AP can know that the STA has a co-existence constraint and can allocate RUs such that the STA can continue operating using multiple communication protocols concurrently (e.g., Wi-Fi, Bluetooth, UWB, Zigbee, among others) and minimizing interference from each other by using different RUs for the different communication protocols, improving wireless communication and the performance of applications that use the different communication protocols.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
transmit, to an access point (AP), a first frame using a first communication protocol, the first frame indicating unavailability associated with a coexistence constraint imposed by a second communication protocol, the first frame including resource information indicating an unavailable resource;
receive, from the AP, a second frame using the first communication protocol, the second frame allocating a resource that is determined to avoid interference by the coexistence constraint; and
perform communication with the AP based on the allocated resource.

2. The STA of claim 1, wherein:
the first frame indicates a first resource unit that is unavailable by the coexistence constraint; and
the second frame allocates a second resource unit that is determined to avoid the interference.

3. The STA of claim 2, wherein the first frame indicates a duration of unavailability of the first resource unit.

4. The STA of claim 2, wherein the first frame includes:
a first field indicating one or more resource units that are unavailable;
a second field indicating a start time of unavailability for the one or more resource units; and
a third field indicating a duration of unavailability for the one or more resource units.

5. The STA of claim 1, wherein the processor is further configured to receive, from the AP, a third frame that solicits the first frame.

6. The STA of claim 5, wherein the third frame includes information on one or more resource units that are allowed to be allocated to the STA.

7. The STA of claim 1, wherein the processor is further configured to receive, from the AP, a frame that indicates a capability to support resource allocation based on the coexistence constraint.

8. The STA of claim 1, wherein the processor is further configured to transmit, to the AP, a frame that indicates a capability to support resource allocation based on the coexistence constraint.

9. An access point (AP) in a wireless network, the AP comprising:
a memory; and
a processor coupled to the memory, the processor configured to:
receive, from a station (STA), a first frame, the first frame indicating unavailability associated with a coexistence constraint imposed by a communication protocol that is different than a communication protocol used by the AP, the first frame including resource information indicating an unavailable resource;
transmit, to the STA, a second frame, the second frame allocating a resource that is determined to avoid interference by the coexistence constraint; and
perform communication with the STA based on the allocated resource.

10. The AP of claim 9, wherein:
the first frame indicates a first resource unit that is unavailable by the coexistence constraint; and
the second frame allocates a second resource unit that is determined to avoid the interference.

11. The AP of claim 10, wherein the first frame indicates a duration of unavailability of the first resource unit.

12. The AP of claim 10, wherein the first frame includes:
a first field indicating one or more resource units that are unavailable;
a second field indicating a start time of unavailability for the one or more resource units; and
a third field indicating a duration of unavailability for the one or more resource units.

13. The AP of claim 9, wherein the processor is further configured to transmit, to the STA, a third frame that solicits the first frame.

14. The AP of claim 13, wherein the third frame is transmitted to a plurality of STAs and includes identification information for the plurality of STAs that the third frame is intended for.

15. The AP of claim 13, wherein the third frame includes information on one or more resource units that are allowed to be allocated to the STA.

16. The AP of claim 9, wherein the processor is further configured to transmit, to the STA, a frame that indicates a capability to support resource allocation based on the coexistence constraint.

17. The AP of claim 9, wherein the processor is further configured to receive, from the STA, a frame that indicates a capability to support resource allocation based on the coexistence constraint.

18. A computer-implemented method for wireless communication by a station (STA) in a wireless network, comprising:
transmitting, to an access point (AP), a first frame using a first communication protocol, the first frame indicating unavailability associated with a coexistence constraint imposed by a second communication protocol, the first frame including resource information indicating an unavailable resource;
receiving, from the AP, a second frame using the first communication protocol, the second frame allocating a resource that is determined to avoid interference by the coexistence constraint; and
performing communication with the AP based on the allocated resource.

19. The computer-implemented method of claim 18, wherein:
the first frame indicates a first resource unit that is unavailable by the coexistence constraint; and
the second frame allocates a second resource unit that is determined to avoid the interference.

20. The computer-implemented method of claim 19, wherein the first frame indicates a duration of unavailability of the first resource unit.
